(19) United States
(12) Patent Application Publication
(10) Pub. No.: US 2006/0176417 A1
(43) Pub. Date: Aug. 10, 2006

(54) Flat panel display

(76) Inventors: Bing-Seng Wu, Tainan City (TW); Chien-Yu Lin, Tainan County (TW); Wei-Ching Cho, Tainan County (TW)

Correspondence Address: FISH & RICHARDSON PC, P.O. BOX 1022, MINNEAPOLIS, MN, 55440-1022, US

(21) Appl. No.: 11/341,888

(22) Filed: Jan. 27, 2006

(30) Foreign Application Priority Data
Feb. 4, 2005 (TW) 94103920

(51) Int. Cl. G02F 1/1333

(52) U.S. Cl. 349/58

(57) ABSTRACT

A display includes a first substrate, a second substrate, and a functional layer positioned between the first and second substrates. The functional layer modulates light to generate an image. A chip is disposed on the first substrate, in which the chip and the second substrate are positioned at a same side of the first substrate. The chip has a thickness that is greater than a thickness of the second substrate. A polarizer is disposed on the second substrate, in which the polarizer and the functional layer positioned at opposite sides of the second substrate. The sum of thicknesses of the functional layer, the second substrate, and at least a portion of the polarizer is greater than a thickness of the chip.

### CROSS-REFERENCE TO RELATED APPLICATIONS

This application claims priority to Taiwan application Serial No. 94103920, filed Feb. 4, 2005, the contents of which are incorporated by reference.

### BACKGROUND OF THE INVENTION

The description relates to flat panel displays.

Flat panel displays are used, for example, in televisions, computer displays, portable video players, game consoles, personal digital assistants (PDAs), car navigation displays, and aviation cockpit displays. Examples of the flat panel displays include liquid crystal displays, electro-luminescent displays, liquid crystal on silicon (LCOS) projection displays, and field-emission displays.

A liquid crystal display includes a liquid crystal layer disposed between two substrates. The substrates can be made of glass or non-glass materials. FIG. 15 is a table that shows different types of substrates that can be used in liquid crystal displays. Currently, commercially available glass substrates have thicknesses that range from 0.5 mm to 1.1 mm. Glass substrates are available from companies such as Corning, Asahi, NHT, and NSG.

Various techniques are being developed for generating glass substrates having thicknesses less than 0.5 mm. For example, glass substrates can be made thinner by a thinning grinding process or an etch transfer process, to thicknesses of about 0.1 mm to 0.3 mm. During the SID Information and Display Conference 2002, Toshiba Corporation presented a thinning grinding technology that grinds a 0.7 mm glass substrate to a thinner glass substrate having a thickness of 0.3 mm. In 2003, Seiko-Epson Corporation presented a thinning grinding technology that can produce a glass substrate having a thickness of 0.1 mm. Companies such as Sony and Seiko-Epson have been developing etch transfer processes. A thin glass layer can also be bonded with a flexible material layer to form a laminate glass substrate. The flexible substrate prevents the thin glass layer from cracking during manufacturing and subsequent handling. Laminate glass substrates having thicknesses of, for example, 0.1 mm to 0.3 mm have been fabricated. Companies such as Schott and Agfa have been developing laminate glass substrates.

Non-glass substrates, which include flexible substrates and thin metal foil substrates, are being developed to achieve thicknesses less than 0.5 mm. Flexible substrates can be made of plastic material, such as polyethersulfone (PES) or polyethylene (PET). Flexible substrates having thicknesses that range from 0.1 mm to 0.3 mm have been fabricated. In 2000, Sharp Corporation presented a 2-inch color super twisted nematic liquid crystal display using a flexible substrate. During the SID Information and Display Conference 2002, Philips Corporation presented a flexible cholesteric display device using a flexible substrate. In the SID Information and Display Conference 2004, Samsung Corporation presented a 2.2-inch plastic display device using a flexible substrate.

Thin metal foil substrates can have thicknesses of 0.05 mm to 0.1 mm, depending on the extensibility of the metal material. Thin metal foil substrates can be made of, for example, titanium, SS304 stainless steel, aluminum and iron-nickel alloy. Research institutes such as Princeton University and Lehigh University have been conducting research on thin metal foil substrates.

A liquid crystal display includes integrated circuit (IC) chips that include circuitry (such as gate drivers and column drivers) for controlling the pixels of the display. The IC chips can be packaged using chip on board (COB) technology, tape automated bonding (TAB) technology, and flip chip bonding technology. In flip chip bonding, the chips are bonded directly on one of the substrates. The term “chip on glass” (COG) refers to the structure in which IC chips are bonded directly on a glass substrate. The IC chips can have thicknesses equal to or larger than about 0.3 mm.

FIG. 1 is an exploded diagram of an example of a display module 1 of a liquid crystal display. The display module 1 includes a metal frame 11, a first polarizer 12, a color filter (CF) substrate 13, a liquid crystal layer (not shown in the diagram), a thin film transistor (TFT) substrate 14, a second polarizer 15, a protector sheet 16, a first optical sheet 17, a second optical sheet 18, a diffuser sheet 19, a light guide plate (LGP) 20, a reflector sheet 21, a mold frame 22, and a lamp assembly (not shown in the diagram). A color filter is disposed on the CF substrate 13, and thin film transistors are disposed on the TFT substrate 14. A number of chips 23, such as IC chips, are bonded on the TFT substrate 14 via the flip chip bonding technology to form chip on glass (COG) structures.

FIG. 2 is a perspective view of the display module 1 after the components shown in FIG. 1 are assembled together. The metal frame 11 defines a “non-contact area” 24 and a “contact area” 25. The non-contact area 24 refers to the open region that is not covered by the metal frame 11, and the contact area 25 refers to the region that is covered by the metal frame 11 (as seen from a position of a user). Pixels of the display that are located at the non-contact area 24 are not blocked by the metal frame and can be viewed by a user.

FIG. 3 shows a cross-sectional view along the segment line 3-3 of FIG. 2. The TFT substrate 14 has a top surface 141 and a bottom surface 142. The chip 23 is disposed on the top surface 141 of the TFT substrate 14. The color filter substrate 13 is positioned above the TFT substrate 14, and a liquid crystal layer (not shown) is disposed between the color filter substrate 13 and the TFT substrate 14. The first polarizer 12 is attached to the color filter substrate 13. The second polarizer 15 is attached to the bottom surface 142 of the TFT substrate 14. The protector sheet 16, the first optical sheet 17, the second optical sheet 18, the diffuser sheet 19, the light guide plate 20, and the reflector sheet 21 are disposed below the second polarizer 15.

The mold frame 22 can be made of, for example, a plastic material, such as polycarbon. The mold frame 22 receives and supports the color filter substrate 13, the liquid crystal layer, the TFT substrate 14, the second polarizer 15, the protector sheet 16, the first optical sheet 17, the second optical sheet 18, the diffuser sheet 19, the light guide plate 20, the reflector sheet 21, and the lamp assembly (not shown). The mold frame 22 has a shape that corresponds to the shapes of the various components supported by the mold frame 22. An aluminum backboard 76 is attached to the underside of the mold frame 22.

The metal frame 11 has a shape that corresponds to the shape of the mold frame 22. The metal frame 11 includes a top rib 111, a side rib 112 and a bottom rib 113. The metal frame 11 is mounted on the outside of the mold frame 22 for securing the components of the display module 1. The metal frame 11 can also provide a ground reference for the circuitry of the display.

In this description, when a first layer is said to be “above” a second layer, it means that the first layer is closer to the surface of the display facing the end user, as compared to the second layer. When a first layer is said to be “below” a second layer, it means that the first layer is farther away from the surface of the display facing the end user, as compared to the second layer.

### SUMMARY

In one aspect, in general, a display that includes a first substrate, a functional layer, and a second substrate, the first and second substrates positioned at opposite sides of the functional layer. A chip is disposed on the first substrate, the chip and the second substrate positioned at a same side of the first substrate, the chip having a thickness that is greater than a thickness of the second substrate. A polarizer is disposed on the second substrate, the polarizer and the functional layer positioned at opposite sides of the second substrate. The sum of thicknesses of the functional layer, the second substrate, and at least a portion of the polarizer is greater than a thickness of the chip.

Implementations of the display may include one or more of the following features. At least one of the first substrate and the second substrate includes a glass layer, a layer of flexible material, a thin metal foil, a laminate of a glass layer and a layer of flexible material, a glass layer that was made thin by grinding, and a glass layer that was made thin by etch transfer. The functional layer includes a liquid crystal layer, an electro-luminescent layer, or a field emitter layer. The functional layer includes cells that module light to generate an image. The first substrate includes a thin film transistor (TFT) substrate, an electro-luminescent substrate, a silicon substrate, or a field emitter substrate. The second substrate includes a color filter (CF) substrate or a counter substrate. In some examples, the polarizer has a peripheral area and a central area, the peripheral area having a thickness that is larger than a thickness of the central area. A sum of thicknesses of the functional layer, the second substrate, and the peripheral area of the polarizer is greater than the thickness of the chip. The display includes a mold frame for receiving and supporting the first substrate, and a metal frame that contacts the peripheral area of the polarizer but does not contact the chip. In some examples, the polarizer has a uniform thickness. The display includes a backlight module and a power supply for providing power to the backlight module and the chip. The chip includes at least one of a gate driver and a column driver.

In another aspect, in general, a display that includes a first substrate, a second substrate, a chip, and a mold frame. The first substrate has a surface that defines a plane. The chip is disposed on the surface of the first substrate, the entire chip being within a first distance to the plane. The chip has a thickness that is larger than a thickness of the second substrate. The second substrate and the chip are positioned at a same side of the first substrate. A mold frame receives and supports the first substrate, the mold frame having a portion that is at a second distance from the plane, the second distance being greater than the first distance.

Implementations of the display may include one or more of the following features. The display includes a polarizer, the polarizer and the first substrate being positioned at opposite sides of the second substrate. The display includes a metal frame that contacts the polarizer and/or the mold frame, and does not contact the chip. The display includes a buffer material positioned between the chip and the metal frame.

In another aspect, in general, a display that includes a first substrate, a chip disposed on the first substrate, and a second substrate, the second substrate and the chip positioned at a same side of the first substrate, the second substrate having a thickness that is smaller that a thickness of the chip. The display includes a mold frame to receive and support the first substrate, and a metal frame to secure the first substrate and the second substrate to the mold frame, the metal frame including a top rib positioned above the chip.

Implementations of the display may include one or more of the following features. The top rib is configured and designed to have a shape such that the top rib does not contact the chip when the top rib is pressed towards the mold frame. In some examples, the top rib includes an indentation that defines a space between the top rib and the chip. The top rib includes a first portion, a second portion and a third portion, the second portion having two ends that extend downward to connect the first portion and the third portion to form the indentation, the second portion having a lower surface that is above the chip, and at least one of the first and third portions has a lower surface that is lower than an upper surface of the chip. The first portion of the top rib contacts the second substrate. The first portion of the top rib contacts a polarizer disposed on the second substrate. The third portion of the top rib contacts the mold frame. In some examples, the top rib has an opening such that when the top rib is pressed towards the mold frame, at least a portion of the chip passes the opening without contacting the top rib.

In another aspect, in general, an apparatus that includes a first substrate having a top surface, a bottom surface, and four corners, a chip disposed on the top surface of the first substrate, a second substrate, and a functional layer positioned between the first and second substrates, the functional layer comprising cells to modulate light. The display also includes a mold frame to receive and support the first substrate, and a plurality of brackets positioned at the corners of the mold frame to secure the first and second substrates to the mold frame.

Implementations of the display may include one or more of the following features. The chip has a thickness that is greater than the second substrate.

In another aspect, in general, a display that includes a functional layer disposed between a lower substrate and an upper substrate, a chip, and a polarizer. The functional layer has cells to modulate light. The chip is disposed on the lower substrate, the chip and the functional layer being on the same side of the lower substrate. The chip has circuitry to control the cells of the functional layer, and has a thickness that is greater than the upper substrate. The polarizer is disposed on the upper substrate, the polarizer and the functional layer being on opposite sides of the upper substrate. The polarizer has a thickness such that a sum of thicknesses of the functional layer, the upper substrate, and a portion of the polarizer is greater than a thickness of the chip.

Implementations of the display may include one or more of the following features. The polarizer has a peripheral region and a central region, the peripheral region having a thickness that is larger than the central region. The chip has a thickness that is less than a sum of thicknesses of the functional layer, the upper substrate, and the peripheral region of the polarizer. The display includes a mold frame and a metal frame. The mold frame supports the lower substrate, the functional layer, the upper substrate, and the polarizer. The metal frame contacts the peripheral region of the polarizer and does not contact the chip.

In another aspect, in general, a method of assembling a display includes bonding a first substrate to a second substrate, bonding a polarizer to the second substrate, attaching a chip to the first substrate, the chip having a thickness that is greater than a thicknesses of the second substrate, supporting the first substrate with a mold frame, and attaching a metal frame to the mold frame, the metal frame contacting the polarizer and not contacting the chip.

Implementations of the method may include one or more of the following features. The polarizer has a peripheral region and a central region, the peripheral region having a thickness that is larger than the central region. The chip has a thickness that is less than a sum of thicknesses of the functional layer, the upper substrate, and the peripheral region of the polarizer. The first substrate includes a thin film transistor (TFT) substrate, an electro-luminescent substrate, a silicon substrate, or a field-emitter substrate. The second substrate includes a color filter (CF) substrate or a counter substrate.

Advantages include use of thinner substrates so that the overall thickness of the display or apparatus can be reduced. Even though the chip has a thickness that is greater than a thickness of the upper substrate, the metal frame does not contact the chip so that the chip will not be damaged by the metal frame. The metal frame also protects the chip from being damaged by external forces.

### DESCRIPTION OF DRAWINGS

FIGS. 1, 2, and 3 are an exploded diagram, a perspective view, and a cross-sectional view, respectively, of a display module.

FIGS. 4, 5, and 6 are an exploded diagram, a perspective view, and a cross-sectional view, respectively, of a display module.

FIG. 7 is a diagram of a polarizer.

FIG. 8 is a cross-sectional view of a display module.

FIGS. 9 and 10 are a perspective view and a cross-sectional diagram, respectively, of a display module.

FIGS. 11 and 12 are a perspective view and a cross-sectional view, respectively, of a display module.

FIGS. 13 and 14 are an exploded diagram and a cross-sectional view, respectively, of a display module.

FIG. 15 is a table.

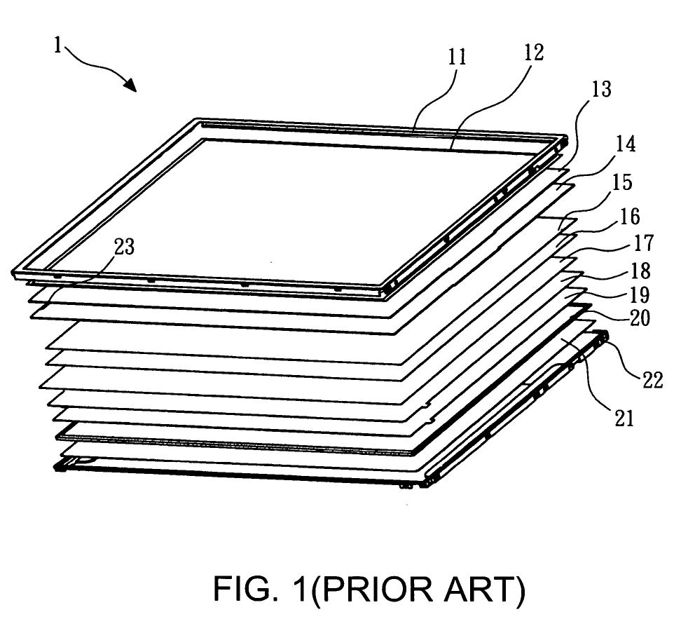

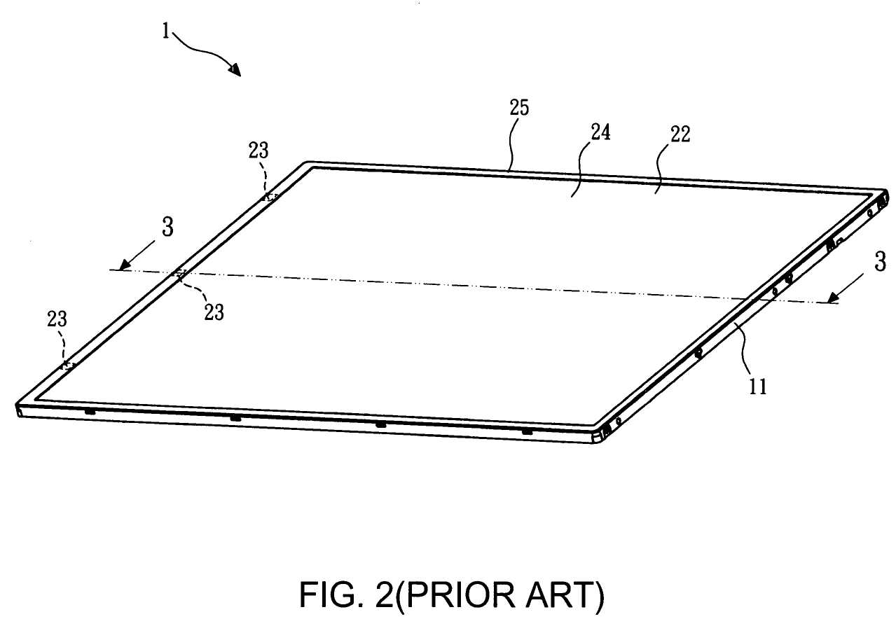

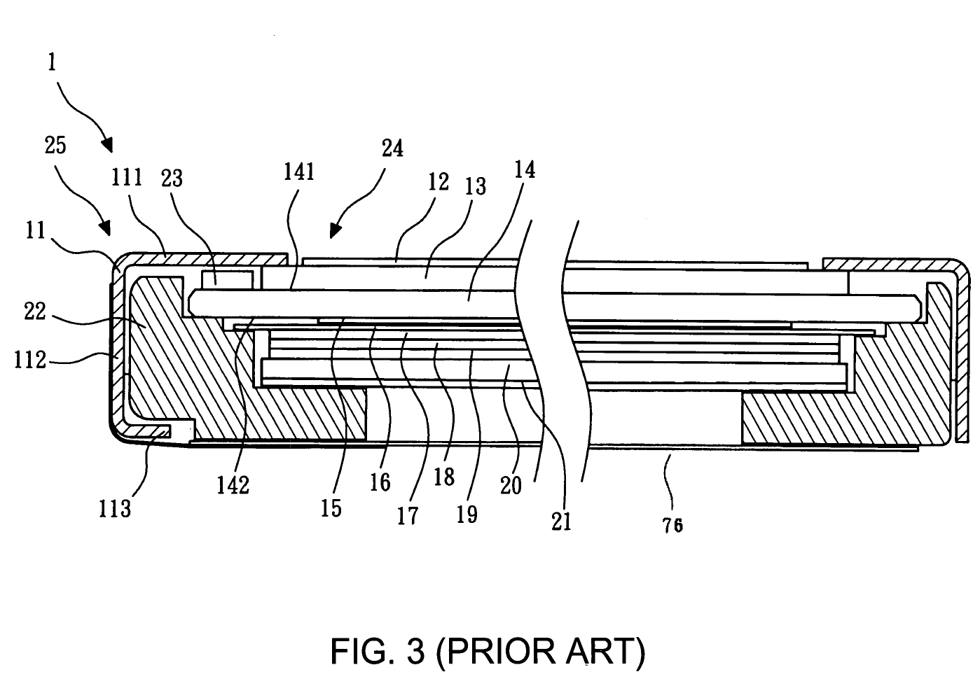

### DESCRIPTION

This description describes several examples of flat panel displays (for example, liquid crystal displays), that have color filter substrates that are thinner than chips disposed on TFT substrates. In each example, the flat panel display is designed so that the chips are less likely to be damaged by a metal frame when, for example, an external force is applied to the metal frame. Such designs allow thinner substrates to be used in the displays, while at the same time preventing damage to circuitry during assembly by factory workers or during use by end users.

### EXAMPLE 1

In this example, a polarizer attached to a color filter substrate is made thicker at the edges so that the sum of the thicknesses of the edge of the polarizer and the color filter substrate is larger than the thickness of an IC chip. When an external force is applied to a metal frame, the metal frame presses against edges of the polarizer and does not contact the IC chip, thus preventing damage to the IC chip.

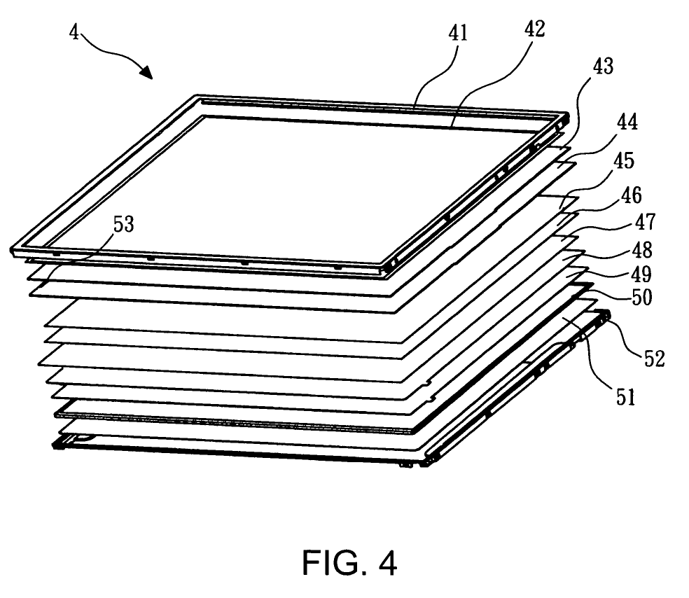

FIG. 4 shows an exploded diagram of a display module 4 of a liquid crystal display. The display module 4 includes a metal frame 41, a first polarizer 42, a first substrate (e.g., TFT substrate) 44, a second substrate (e.g., color filter substrate) 43, a liquid crystal layer (not shown in the diagram), a second polarizer 45, a protector sheet 46, a first optical sheet 47, a second optical sheet 48, a diffuser sheet 49, a light guide plate 50, a reflector sheet 51, a mold frame 52, and a lamp assembly (not shown in the diagram). A number of chips 53, such as integrated circuit (IC) chips, are bonded to the TFT substrate 44 via flip chip bonding technology. The TFT substrate 44 and the color filter substrate 43 can be glass substrates. The glass substrates can be made by thinning grinding or etch transfer technology. The glass substrate can be a laminate glass substrate. The TFT substrate 44 and the color filter substrate 43 can be non-glass substrates, such as flexible substrates and thin metal foils.

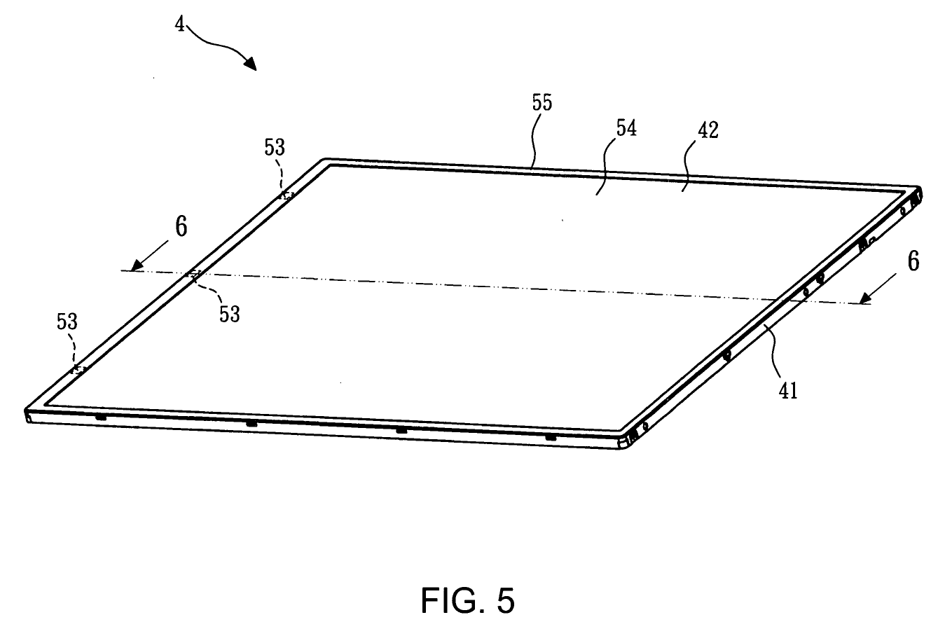

FIG. 5 is a perspective view of the display module 4 of FIG. 4 when the components are assembled together. The metal frame 41 defines a “non-contact area” 54 and a “contact area” 55. The non-contact area 54 refers to the open region that is not covered by the metal frame 41, and the contact area 25 refers to the region that is covered by the metal frame 11 (as seen from a position of a user). Chips 53 are disposed in the contact area 55. Pixels of the display that are located at the non-contact area 54 are not blocked by the metal frame and can be viewed by a user.

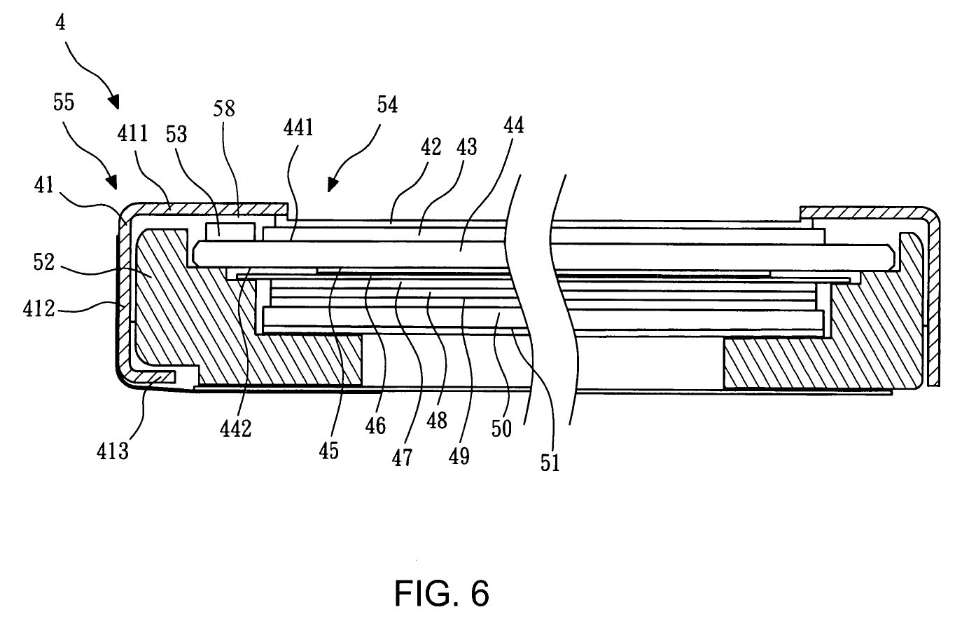

FIG. 6 is a cross-sectional view of the display module 4 of FIG. 5, as viewed along the segment line 6-6. In the display module 4, the TFT substrate 44 has a top surface 441 and a bottom surface 442. The chip 53 is disposed on the top surface 441 of the TFT substrate 44. The color filter substrate 43 is positioned above the TFT substrate 44, and a liquid crystal layer (not shown) is disposed between the TFT substrate 44 and the color filter substrate 43. The first polarizer 42 is attached to the color filter substrate 43. The second polarizer 45 is attached to the bottom surface 442 of the TFT substrate 44. The protector sheet 46, the first optical sheet 47, the second optical sheet 48, the diffuser sheet 49, the light guide plate 50, the reflector sheet 51, and a lamp assembly (not shown) are positioned below the second polarizer 45.

The liquid crystal layer includes cells that modulate light generated by the lamp assembly. Each cell corresponds to a pixel of the display. By controlling the liquid crystal cells to pass different amounts of light, a gray scale image can be generated. Use of color filters allow the images to be shown in color.

The mold frame 52 receives and supports the first polarizer 42, the color filter substrate 43, the liquid crystal layer, the TFT substrate 44, the second polarizer 45, the protector sheet 46, the first optical sheet 47, the second optical sheet 48, the diffuser sheet 49, the light guide plate 50, the reflector sheet 51, and the lamp assembly. The mold frame 52 forms part of the outer frame of the display module 4. The metal frame 41 has a shape that corresponds to the shape of the mold frame 52. The metal frame includes a top rib 411, a side rib 412, and a bottom rib 413. The metal frame 41 is disposed outside the mold frame 52 for securing the display module 4. The top rib 411 has a bottom surface that contacts the first polarizer 42. The top rib 411 covers the chip 53 and prevents the chip 53 from being damaged by an external force.

In example 1, the thickness of the second substrate 43 is smaller than the thickness of the chip 53 (which is about 0.3 mm). The thickness of the first polarizer 42 is selected so that the sum of the thicknesses of the first polarizer 42 and the second substrate 43 is larger than the thickness of the chip 53. Alternatively, the sum of the thicknesses of the liquid crystal layer, the second substrate 43, and the first polarizer 42 is larger than the thickness of the chip 53. As a result, a space 58 is formed between the top rib 411 of the metal frame 41 and the chip 53. When an external force presses the top rib 411 towards the chip 53, the first polarizer 42 supports the top rib 411, preventing the top rib 411 from pressing and damaging the chip 53. For example, the external force may be imparted by a user grabbing the edges of the display, or by an assembly working assembling the metal frame 41 with other components.

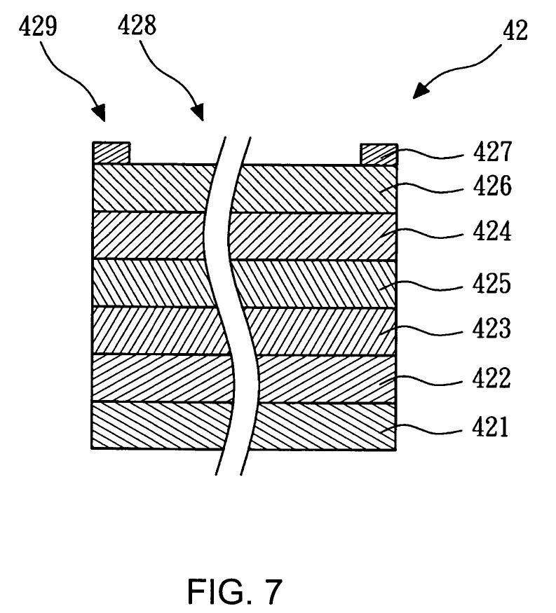

FIG. 7 is a diagram of the first polarizer 42 of example 1. The first polarizer 42 includes a release film 421, an adhesive 422, triacetate cellulose (TAC) layers 423, 424, a protection film 426, a buffer material 427, and a PVA layer 425 including iodine molecules. The buffer material 427 surrounds the peripheral of the first polarizer 42 to form a peripheral area 429 and a central area 428 surrounded by the peripheral area 429. The thickness of the peripheral area 429 is larger than the thickness of the central area 428. The sum the thicknesses of the peripheral area 429 and the second substrate 43 is larger than the thickness of the chip 53. In some examples, the peripheral area 429 of the first polarizer 42 corresponds to the contact area 55, and the central area 428 of the first polarizer 42 corresponds to the non-contact area 54.

The first polarizer 42 can be different from that shown in FIG. 7, and does not necessarily have the buffer material 427. For example, the first polarizer 42 can have a uniform thickness, and the thickness of one or more layers of the first polarizer 42 can be increased, as compared to those in FIG. 7. The thickness of the protection film 426 or the thickness of the triacetate cellulose (TAC) layers 423 and 424 can be increased. In some examples, a functional layer such as an anti-reflection layer, an anti-dazzle layer, a protection layer, or an anti-moisture layer can be added to the first polarizer 42. For example, one or more anti-reflection layers, anti-dazzle layers, or protection layers can be attached to the TAC layers 423 and 424 to increase the thickness and optical performance of the polarizer 42.

When assembling the display module 4, the color filter substrate 43 is bonded to the thin film transistor substrate 44 with spacers in between. A liquid crystal material is injected into a space between the substrates 43 and 44. Sealants are applied to seal the liquid crystal material inside the space between the substrates. The polarizer 42 is bonded to the CF substrate 43, and the polarizer 45 is bonded to the TFT substrate 44. Chips 53 are flip-chip bonded to the TFT substrate 44. The chips can have thicknesses of about 0.3 mm or greater, whereas the CF substrate 43 has a thickness less than 0.3 mm. The protector sheet 46, the first optical sheet 47, the second optical sheet 48, the diffuser sheet 49, the light guide plate 50, the reflector sheet 51, and the lamp assembly are assembled together with the substrate 44, after which the components are placed onto the mold frame 52. The metal frame 41 is attached to the mold frame 52 to secure the components in place. During assembling, care is taken so that the metal frame 41 does not contact the chips 53.

### EXAMPLE 2

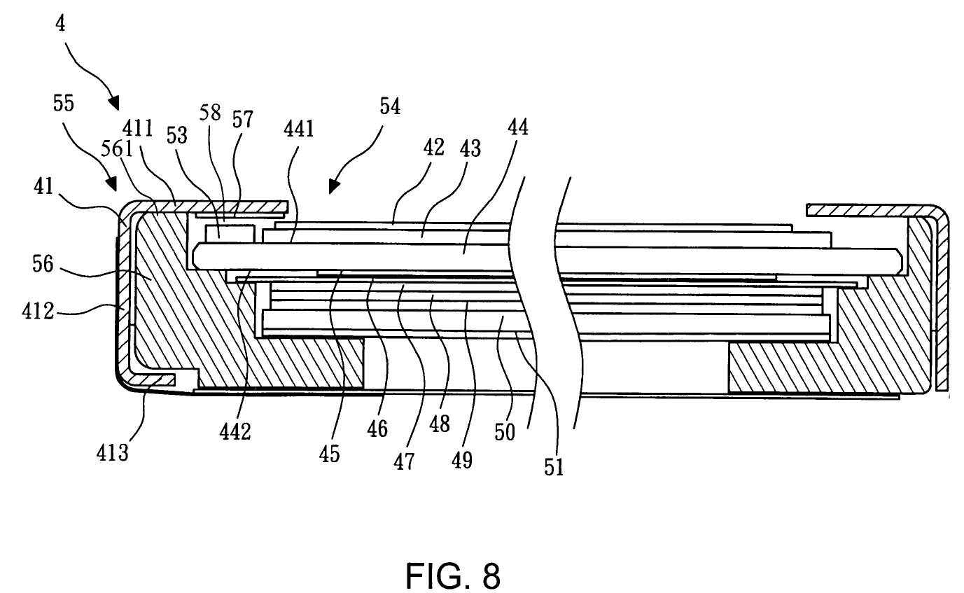

FIG. 8 is a cross-sectional view of a second example of a display module 4. The same reference numbers will be used for similar components in FIGS. 6 and 8. Example 2 is similar to example 1, in which the thickness of the second substrate 43 is smaller than the thickness of the chip 53. Example 2 is different from example 1 in that a mold frame 56 has a portion 561 that is higher than the chip 53. The portion 561 supports the top rib 411 of the metal frame 41 and prevents the top rib 411 from contacting the chip 53. The top surface 441 of the substrate 44 defines a plane P. The mold frame 56 is designed such that d2>d1, in which d2 is the distance between the portion 561 and the plane P, and d1 is the distance between the highest surface of the chip 53 and the plane P. A space 58 is formed between the top rib 411 and the chip 53 to prevent the top rib 411 from pressing the chip 53. In some examples, a buffer material 57 is bonded to the bottom surface of the top rib 411.

### EXAMPLE 3

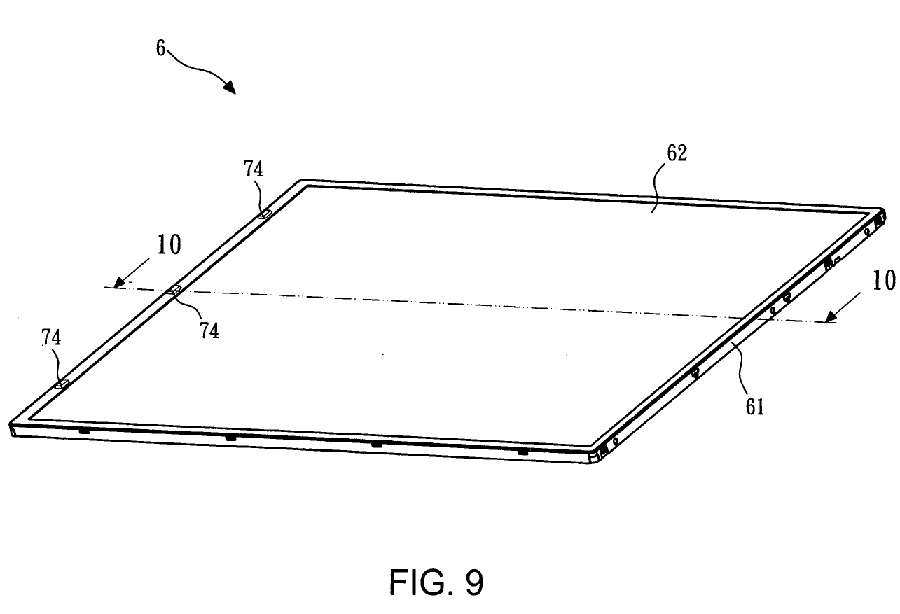

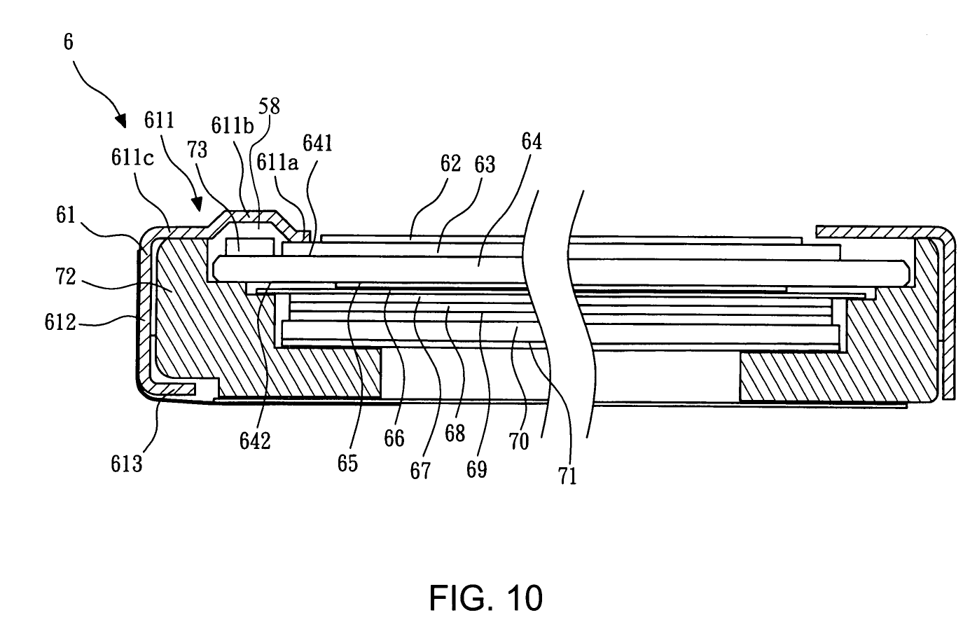

FIGS. 9 and 10 show a perspective view and a cross-sectional view, respectively, of a third example of a display module 6. The display module 6 can be part of a flat panel display, such as a liquid crystal display. The display module 6 includes a metal frame 61, a first polarizer 62, a first substrate 64, a second substrate 63, a liquid crystal layer (not shown in the diagram), a second polarizer 65, a protector sheet 66, a first optical sheet 67, a second optical sheet 68, a diffuser sheet 69, a light guide plate 70, a reflector sheet 71, a mold frame 72, and a lamp assembly (not shown in the diagram). A number of chips 73, such as IC chips, can be bonded on the first substrate 64 via flip chip bonding technology. In example 3, the first substrate 64 can be a TFT substrate, and the second substrate 63 can be a color filter substrate. Each of the first and second substrates 64 and 63 can be a glass substrate, a flexible substrate, or a thin metal foil. The glass substrate can be made by a thinning grinding process or an etch transfer process. The glass substrate can be a laminate glass substrate.

The first substrate 64 has a top surface 641 and a bottom surface 642. The chip 73 is disposed on the top surface 641 of the first substrate 64. The second substrate 63 is positioned above the first substrate 64. A liquid crystal layer (not shown) is positioned between the second substrate 63 and the first substrate 64. The first polarizer 62 is bonded to the top surface of the second substrate 63. The second polarizer 65 is bonded to the bottom surface 642 of the first substrate 64. A mold frame 72 receives and supports the first polarizer 62, the second substrate 63, the liquid crystal layer, the first substrate 64, the second polarizer 65, the protector sheet 66, the first optical sheet 67, the second optical sheet 68, the diffuser sheet 69, the light guide plate 70, the reflector sheet 71 and the lamp assembly. The mold frame 72 forms a portion of the outer frame of the display module 6.

The shape of the metal frame 61 corresponds to the shape of the mold frame 72. The metal frame 61 is disposed outside of the mold frame 72 for securing the components of the display module 6. The metal frame 61 includes a top rib 611, a side rib 612 and a bottom rib 613. The top rib 611 has a structure to prevent the bottom surface of the top rib 611 from pressing the chip 73. The top rib 611, when viewed from below, has an indentation positioned above the chip 73 so that a space 58 is generated between the top rib 611 and the chip 73. The top rib 611, when viewed from above, has a protrusion 74 (see FIG. 9) that is slightly larger than the size of the chip 73.

In example 3, the top rib 611 includes a first portion 611a, a second portion 611b and a third portion 611c. The second portion 611b correspond to the protrusion 74, and is positioned above the chip 73. The two ends of the second portion 611b extend downward and connect to the first portion 611a and the third portion 611c, respectively. The first portion 611a and the third portion 611c can be positioned at a same level (i.e., having a same distance to a plane defined by the top surface 641 of the second substrate 64), or at different levels. The first portion 611a contacts the top surface of the second substrate 63 or the first polarizer 62. The third portion 611c contacts the mold frame 72. When an external force presses the top rib 611 toward the chip 73, the mold frame 72 and the top surface of the second substrate 63 or the first polarizer 62 support the top rib 611 so that the top rib 611 does not press against the chip 73.

In example 3, the second substrate 63 can have a thickness that is equal to or larger than the thickness of the chip 73. In some examples, the indentation at the bottom surface of the top rib 611 can be formed by thinning a portion of the underside of the top rib 611 that faces the chip 73. In such cases, the top surface of the top rib 611 can remain flat and does not necessarily form protrusions 74.

### EXAMPLE 4

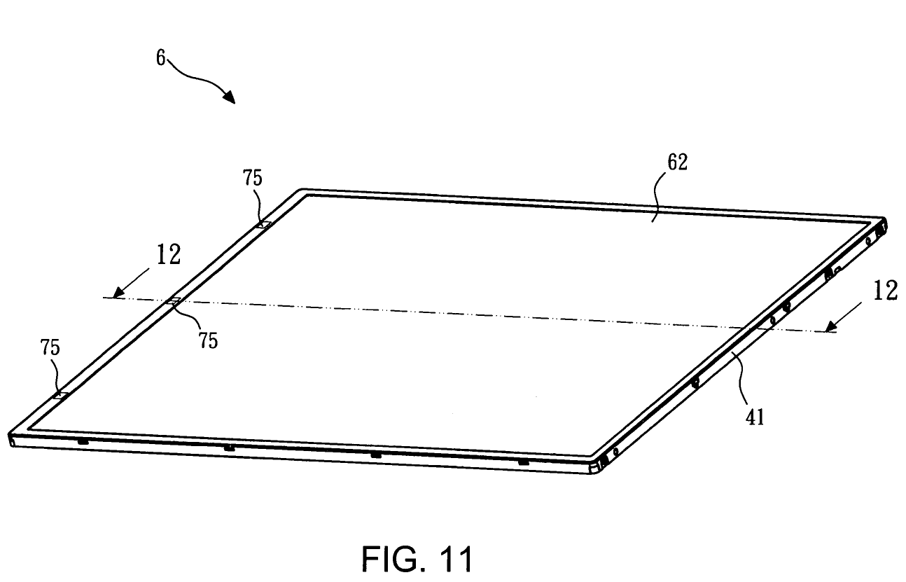

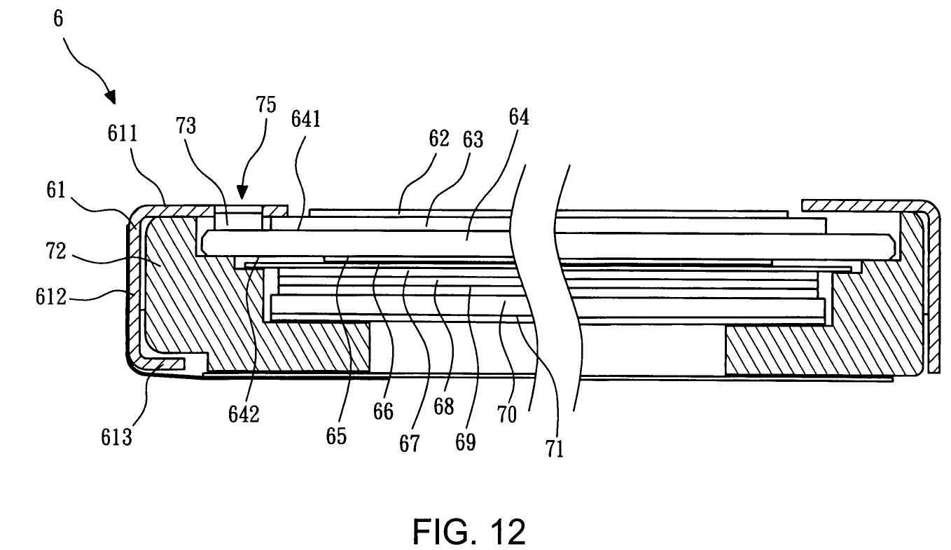

FIGS. 11 and 12 are a perspective view and a cross-sectional view, respectively, of a fourth example of a display module 6. Example 4 is similar to example 3, except that in example 4, the metal frame 61 has openings 75 instead of protrusions and indentations. An opening 75 is positioned above each chip 73 to prevent the top rib 611 from pressing against the chip 73. In some examples, a buffer material is bonded to the bottom surface of the top rib 611 or the top surface of the chip 73 to protect the chip 73, preventing damage to the chip 73 during assembly of the display. In example 4, the second substrate 63 can have a thickness that is smaller than, larger than, or equal to the thickness of the chip 73.

### EXAMPLE 5

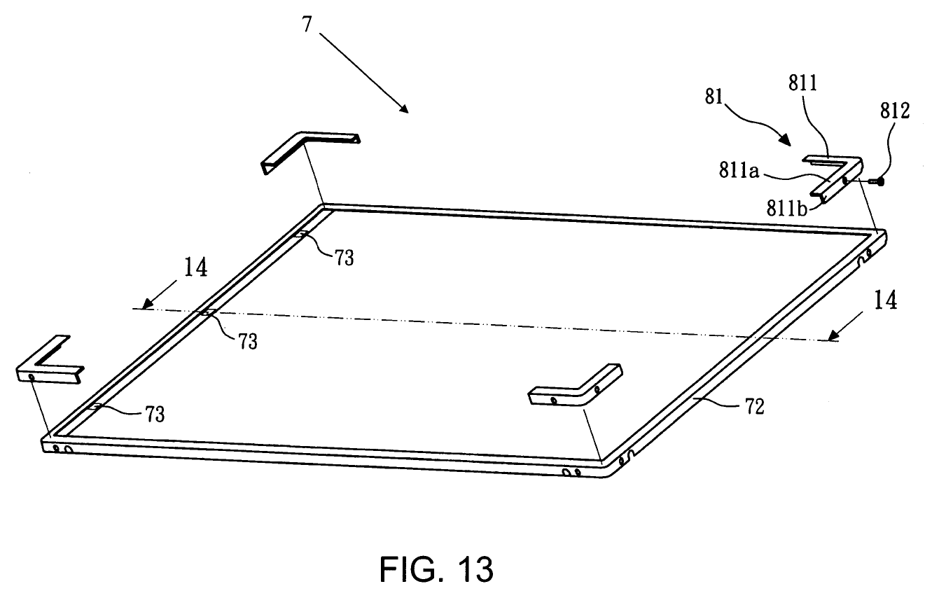

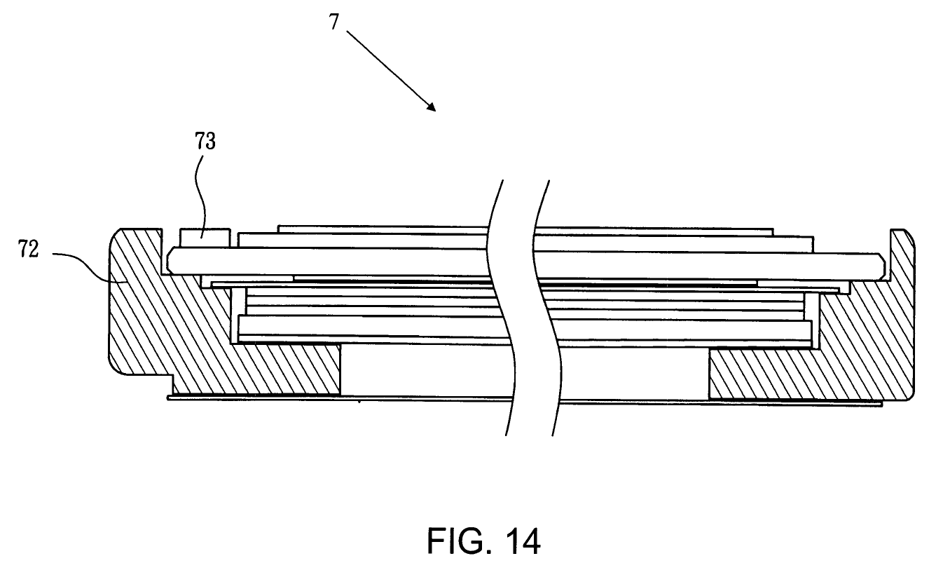

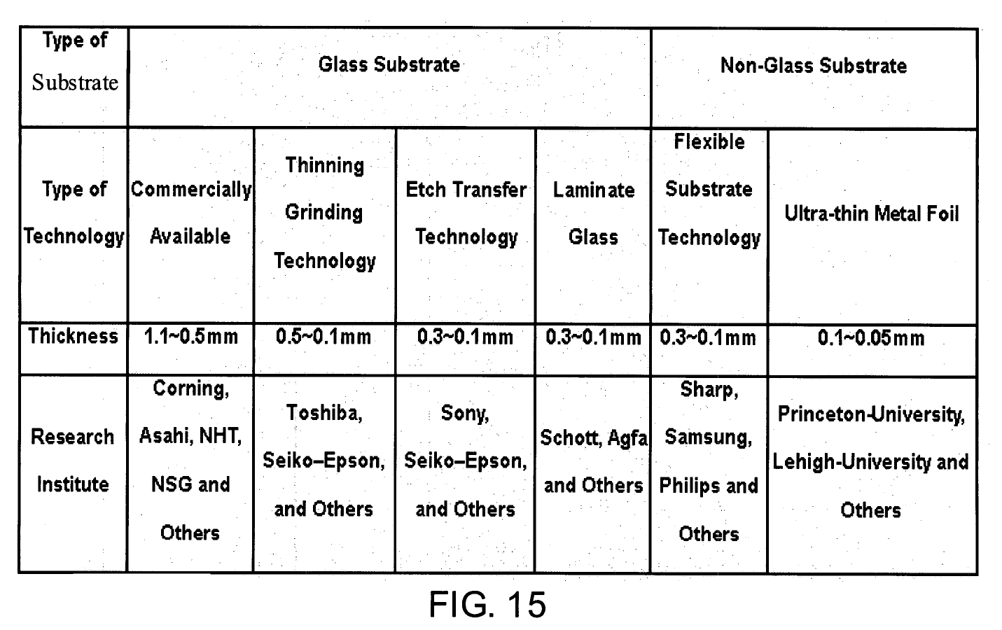

FIGS. 13 and 14 show an exploded diagram and a cross-sectional view, respectively, of a fifth example of a display module 7. Example 5 is similar to example 4, except that in example 5, the display module 7 has a metal frame 81 that includes four metal brackets 811. Each metal bracket 811 is fastened to one of four corners of the mold frame 72 using screws 812. Each metal bracket 811 includes a top rib 811a and a side rib 811b. The screws 812 can be replaced by other mechanisms that can secure the metal bracket to the mold frame 72. For example, a clamp mechanism can be used to clamp the metal bracket 811 to the mold frame 72.

In example 5, the top rib 811a of the metal bracket 811 does not extend to the chip 73, so the bottom surface of the top rib 811a will not press against the chip 73. In some examples, a buffer material is bonded to the top surface of the chip 73 to protect the chip 73 during assembly. In example 5, the second substrate 63 can have a thickness that is smaller than, larger than, or equal to the thickness of the chip 73.

### ALTERNATIVE EXAMPLES

The displays in FIGS. 4-6 and 8-14 can be other types of displays, such as electro-luminescent displays, liquid crystal on silicon (LCOS) projection displays, and field emission displays. For example, in FIG. 6, the display module 4 can be part of a electro-luminescent display, and the substrates 44 and 43 can be an electro-luminescent substrate and a counter substrate, respectively. The display module 4 can be part of a LCOS projection display, and the substrates 44 and 43 can be a silicon substrate and a counter substrate, respectively. The display module 4 can be part of a field emission display, and the substrates 44 and 43 can be a field-emitter substrate and a counter substrate, respectively.

The second substrate (e.g., 43 in FIGS. 6 and 8, 63 in FIGS. 10 and 12) can be positioned below the first substrate (e.g., 44 in FIGS. 6 and 8, 64 in FIGS. 10 and 12), and the chips (53 in FIGS. 6 and 8, 73 in FIGS. 10 and 12) can be disposed on the color filter substrate. The metal frame (41 in FIGS. 6 and 8, 61 in FIGS. 10 and 12, 81 in FIG. 13) can be replaced with a non-metal frame. The non-metal frame prevents the chip from being damaged by an external force, and has a structure such that the frame does not contact the chip when the external force is applied.

Although some examples have been discussed above, other implementations and applications are also within the scope of the following claims.

What is claimed is:

1. A display, comprising:
a first substrate;
a functional layer;
a second substrate, the first and second substrates positioned at opposite sides of the functional layer;
a chip disposed on the first substrate, the chip and the second substrate positioned at a same side of the first substrate, the chip having a thickness that is greater than a thickness of the second substrate; and
a polarizer disposed on the second substrate, the polarizer and the functional layer positioned at opposite sides of the second substrate, wherein the sum of thicknesses of the functional layer, the second substrate, and at least a portion of the polarizer is greater than a thickness of the chip.

2. The display of claim 1 in which at least one of the first substrate and the second substrate comprises a glass layer, a layer of flexible material, a thin metal foil, a laminate of a glass layer and a layer of flexible material, a glass layer that was made thin by grinding, and a glass layer that was made thin by etch transfer.

3. The display of claim 1 in which the functional layer comprises at least one of a liquid crystal layer, an electro-luminescent layer, and a field-emitter layer.

4. The display of claim 1 in which the functional layer comprises cells that module light to generate an image.

5. The display of claim 1 in which the first substrate comprises at least one of a thin film transistor (TFT) substrate, an electro-luminescent substrate, a silicon substrate, and a field-emitter substrate.

6. The display of claim 1 in which the second substrate comprises a color filter (CF) substrate.

7. The display of claim 1 in which the polarizer has a peripheral area and a central area, the peripheral area having a thickness that is larger than a thickness of the central area.

8. The display of claim 7 in which a sum of thicknesses of the functional layer, the second substrate, and the peripheral area of the polarizer is greater than the thickness of the chip.

9. The display of claim 7, further comprising:
a mold frame for receiving and supporting the first substrate; and
a metal frame that contacts the peripheral area of the polarizer but does not contact the chip.

10. The display of claim 1 in which the polarizer has a uniform thickness.

11. The display of claim 1, further comprising:
a mold frame to receive and support the first substrate; and
a metal frame that contacts at least a portion the polarizer but does not contact the chip.

12. The display of claim 1, further comprising a backlight module and a power supply for providing power to the backlight module and the chip.

13. The display of claim 1 in which the chip comprises at least one of a gate driver and a column driver.

14. A display, comprising:
a first substrate having a surface that defines a plane;
a chip disposed on the surface of the first substrate, the entire chip being within a first distance to the plane;
a second substrate, the second substrate and the chip positioned at a same side of the first substrate, the second substrate having a thickness that is smaller than a thickness of the chip; and
a mold frame to receive and support the first substrate, the mold frame having a portion that is at a second distance from the plane, the second distance being greater than the first distance.

15. The display of claim 14, further comprising a polarizer, the polarizer and the first substrate being positioned at opposite sides of the second substrate.

16. The display of claim 15, further comprising a metal frame that contacts the polarizer and does not contact the chip.

17. The display of claim 14, further comprising a metal frame that contacts the portion of the mold frame that is at the second distance from the plane, the metal frame not contacting the chip.

18. The display of claim 17, further comprising a buffer material positioned between the chip and the metal frame.

19. A display, comprising:
a first substrate;
a chip disposed on the first substrate;
a second substrate, the second substrate and the chip positioned at a same side of the first substrate, the second substrate having a thickness that is smaller that a thickness of the chip;
a mold frame to receive and support the first substrate; and
a metal frame to secure the first substrate and the second substrate to the mold frame, the metal frame comprising a top rib positioned above the chip.

20. The display of claim 19 in which the top rib is configured and designed to have a shape such that the top rib does not contact the chip when the top rib is pressed towards the mold frame.

21. The display of claim 19 in which the top rib comprises an indentation that defines a space between the top rib and the chip.

22. The display of claim 21 in which the top rib comprises a first portion, a second portion and a third portion, the second portion having two ends that extend downward to connect the first portion and the third portion to form the indentation, the second portion having a lower surface that is above the chip, and at least one of the first and third portions has a lower surface that is lower than an upper surface of the chip.

23. The display of claim 22 in which the first portion of the top rib contacts the second substrate.

24. The display of claim 22 in which the first portion of the top rib contacts a polarizer disposed on the second substrate.

25. The display of claim 22 in which the third portion of the top rib contacts the mold frame.

26. The display of claim 19 in which the top rib has an opening such that when the top rib is pressed towards the mold frame, at least a portion of the chip passes the opening without contacting the top rib.

27. The display of claim 26 in which the top rib contacts the second substrate.

28. The display of claim 26 in which the top rib contacts a polarizer disposed on the second substrate.

29. The display of claim 26 in which the top rib contacts the mold frame.

30. An apparatus, comprising:
a first substrate having a top surface, a bottom surface;
a chip disposed on the top surface of the first substrate;
a second substrate;
a functional layer positioned between the first and second substrates;
a mold frame to receive and support the first substrate; and
a plurality of brackets positioned at corners of the mold frame to secure the first and second substrates to the mold frame.

31. The apparatus of claim 30 in which the chip has a thickness that is greater than the second substrate.

32. A method of assembling a display comprising:
bonding a first substrate to a second substrate;
bonding a polarizer to the second substrate;
attaching a chip to the first substrate, the chip having a thickness that is greater than a thicknesses of the second substrate;
supporting the first substrate with a mold frame; and
attaching a metal frame to the mold frame, the metal frame contacting the polarizer and not contacting the chip.

33. The method of claim 32 in which the polarizer has a peripheral region and a central region, the peripheral region having a thickness that is larger than the central region.

34. The method of claim 33 in which the chip has a thickness that is less than a sum of thicknesses of the functional layer, the upper substrate, and the peripheral region of the polarizer.

35. The method of claim 33, in which the first substrate comprises at least one of a thin film transistor (TFT) substrate, an electro-luminescent substrate, a silicon substrate, and a field-emitter substrate.

36. The method of claim 33, in which the second substrate comprises a color filter (CF) substrate.
